(19) United States
(12) Patent Application Publication
(10) Pub. No.: US 2007/0162430 A1
(43) Pub. Date: Jul. 12, 2007

(54) Context display of search results

(76) Inventors: Katja Bader, Mannheim (DE); Juergen Lange, Heidelberg (DE); Daniela Wende, Waldorf (Baden) (DE); Shabana Ansari, Bangalore (IN); Hardeep Singh, Punjab (IN); Sathish Kumar, Tamil Nadu (IN); Markus Peter, Leon-Rot (DE)

Correspondence Address: SCHWEGMAN, LUNDBERG, WOESSNER & KLUTH, P.A., P.O. BOX 2938, MINNEAPOLIS, MN, 55402, US

(21) Appl. No.: 11/322,575

(22) Filed: Dec. 30, 2005

(51) Int. Cl. G06F 17/30

(52) U.S. Cl. 707/3

(57) ABSTRACT

A search string is received to be applied to structured data. A concatenated version of the structured data is obtained and the search string is applied to the concatenated version to obtain search results. A list of results is generated and comprises search string correlated information from different portions of the structured data.

### BACKGROUND

Many search engines that search unstructured data, such as web pages and text documents search through whole documents looking for words in a search string. Some search engines display the results in the form a list, taking a snippet of the text, and highlighting search terms that were used in the search string.

Searching for items in structure data may also be done, and may likewise return many results. However, it can be unclear why the results were returned in many instances. This is especially the case with searching of structured data. Structured data is data that is stored in a structured manner, such as records having predetermined fields. A text based search of the structured data, such as the use of a search string without specifying fields, can lead a search application to determine how to apply the search string to the field contents. It can return too many results and results that don't seem to be logical. In other words, it is difficult to tell why the record returned is related to the search string. Applying the search string to each original field, one after the other, can return too few results if the application expects a matching record's field to contain all words of the search string, or too may result if it expects a matching record's field to contain any word of the search string. Either way, the returned results may not appear logical to a user, and it is difficult to determine why some records are returned. There is a need for a better way to display search results for structured data.

### SUMMARY

A search string is received to be applied to structured data. A concatenated version of the structured data is obtained and the search string is applied to the concatenated version to obtain search results. A list of results is generated and consists of search string correlated information from different portions of the structured data.

### BRIEF DESCRIPTION OF THE DRAWINGS

FIG. 1 is a flow chart of a method of searching structured data and providing results in context according to an example embodiment.

FIG. 2 illustrates a portion of a database with a search string and showing a result with context according to an example embodiment.

FIG. 3 illustrates a block diagram of an architecture for searching according to an example embodiment.

FIG. 4 is a screen shot of example results according to an example embodiment.

FIG. 5 is a simplified block diagram of a computer system for executing programs that perform searching functions according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software consists of computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

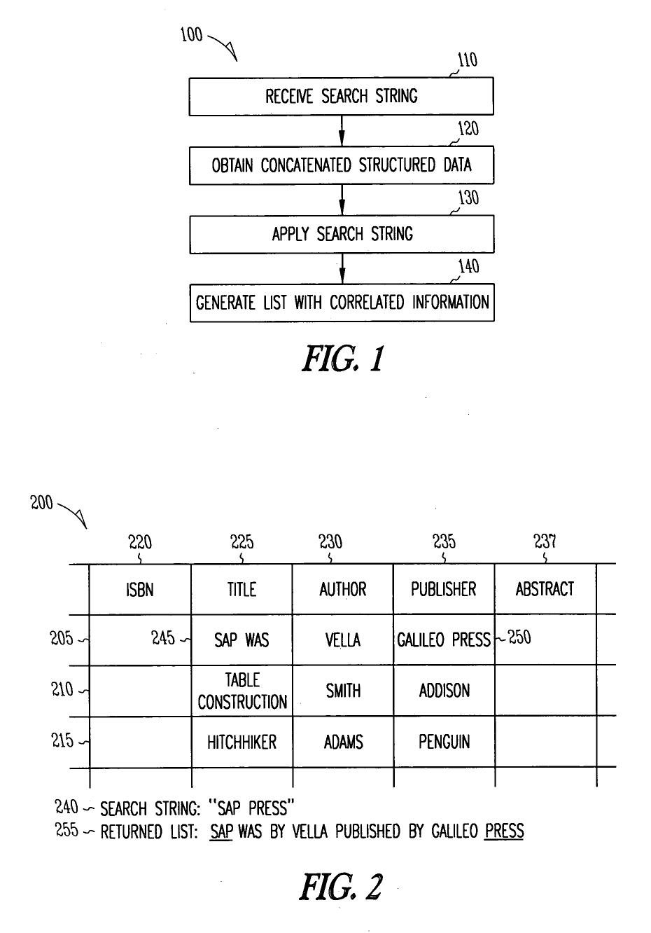

FIG. 1 illustrates a method 100 that may help user understand why items are returned for give search criteria when searching structured data. A context display shows returned items that correlated information from different portions of the structured data to make it easier to understand why the item was returned.

At 110, a search string is received. It may be received from a user using a user interface, or from a process or other entity. The search string is for application to structured data, such as a database having records with multiple fields. In one embodiment, the structured data consists of records relating to items in a catalog. The items may be products, materials, goods, services or other items that may be ordered. In further embodiments, the structured data may be related to information other than product catalogs, such as databases covering literature on various topics, or any other type of information that people may want to search.

At 120, a concatenated form of the structured data is obtained. The concatenated data consists of selected fields of each record placed end to end, or bundled, into a searchable string. While the fields need not be physically stored contiguously, they may be logically bundled in a manner that allows a search string to be applied across the fields of data as represented at 130. In one embodiment, some fields may contain technical data for cross-references between records, and need not be included. Another name for the concatenated form of a record of the structured data is generalized description of the record.

At 140, a list of search results is generated with information that correlates the search results with the search string. In other words, the context in which the information is relevant to the search string is included in the list of search results. The list may be displayed, printed, electronically distributed or stored in various embodiments.

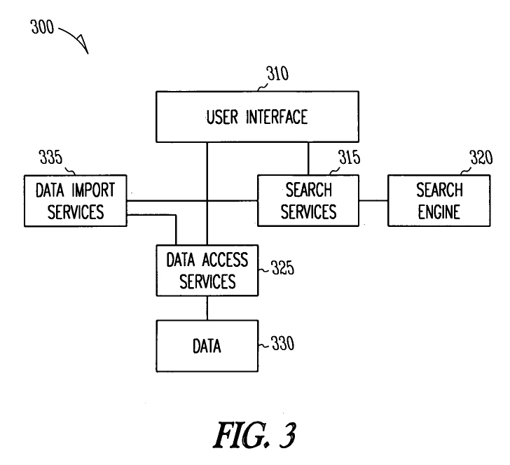

FIG. 2 illustrates a portion of a structured database at 200 related to publications, which may include books, instruction manuals and other publications. This abbreviated illustration of the database shows three records, 205, 210 and 215. The database also shows five columns labeled ISBN 220, title 225, author 230, publisher 235 and abstract 237.

A search string: “sap press” may be entered by a user or otherwise received in a desire to search the database. The search string does not specify in which fields the terms “sap” and “press” occur. Since the record has been concatenated, or logically bundled, the first record 245 is found. “sap” occurs at 245 in the title column 225. “press” occurs at 250 in the publisher column 235. A returned list illustrated at 255 reads “SAP WAS by VELLA published by Galielo Press”. Both “SAP” and “Press” may be provided an attribute to highlight them, such as by underlining as shown, bolding, or many other different attributes that may be provided to text.

Context information in one embodiment consists of portions of the generalized record that contain parts of the search string, as illustrated at 255. The context may be enhanced, as indicated first by the word “by” at 260. The enhancement refers to the Author column 230. This enhanced context information may have also read: “Authored by” to clearly identify that part of the context corresponded to the author column or field. The enhanced context information may be specified by the database, such as in a schema for the database. A second enhanced context information reads: “published by” at 265, referring to the publisher column 235. Thus, in this simple list, the context in which the search result is obtained is clear, both via attributes of words corresponding to the search terms, and by the enhanced context information provided in the results.

FIG. 3 is a block diagram of a system 300 for searching a structured database with search strings, and providing results that show the context of the information provided in the results. A user interface 310 is coupled to a search services function 315. The search services function 315 interfaces with a search engine 320. User interface 310 is coupled to a data access services module 325 that interfaces with a data module 330. A data import services module 335 adds data to data module 330 and also is responsive to search services 315, which may receive requests for data that needs to be imported.

Search strings may be created in conformance with search engine 320 capabilities. Typical search engines may search a string of text, or advanced searches such as those including logical connectors, proximity, and different query languages, such as structured query language and natural language queries. Many other types of queries may be handled by various search engines.

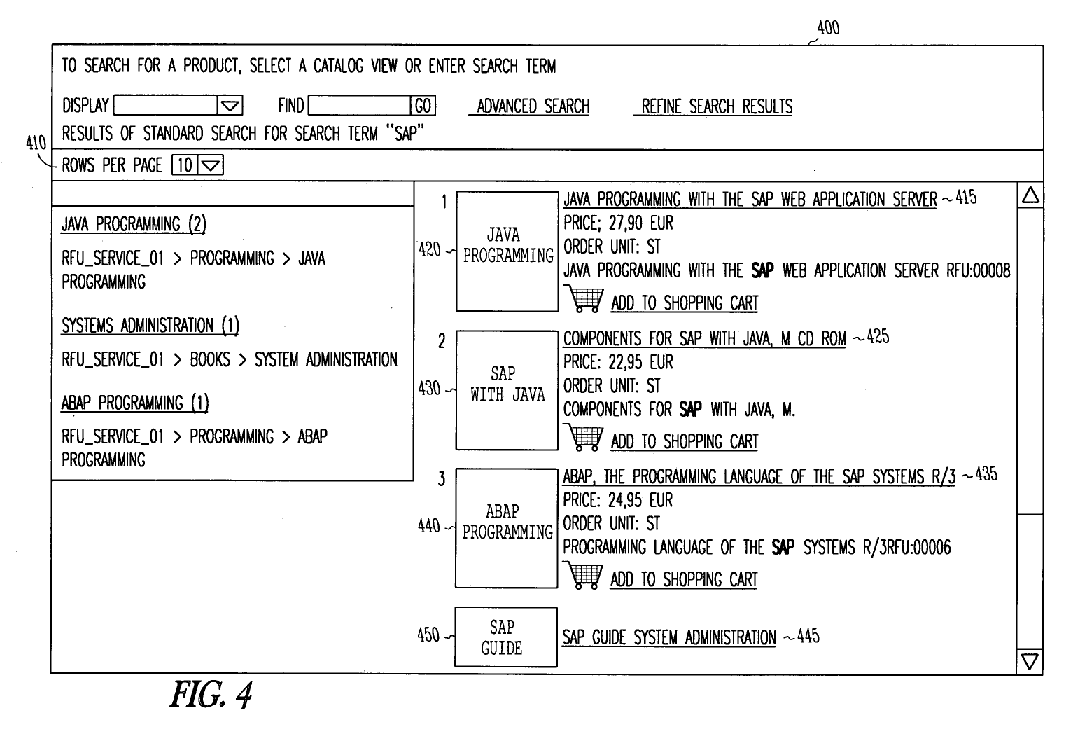

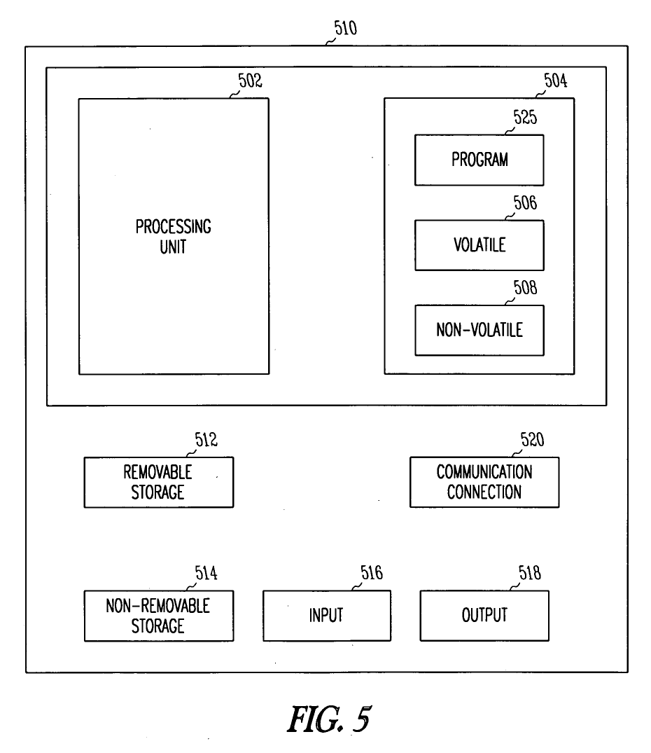

FIG. 4 illustrates a display of a list of search results with context information at 400. A search term of “sap” at 410 provides results that are displayed on a screen for viewing by a user. The results include first result 415, Java Programming with the SAP APP Server, which includes an image 420 of a first page of the book. A shopping cart icon is included with the first result 415, allowing a user to add the book to a list of items to be purchased. Result 415 also includes a link to the book in a catalog, where a user may find more information about the result. Similarly, second result 425, Components for SAP with Java, M CD Rom includes enhanced context information indicating that it comes “with” or “m” CD-ROM. An image 430 is also provided. A third result 435, ABAP, The Programming Language of the SAP—Systems R/S. An image 440 is also included. A fourth result 445, SAP Guide System Administration with image 450 is also provided. The fourth result 445 is not completely shown as indicated by the scrollbar. In this example, the search string consists of a single word, and the results all contain the word in the book's title. It provides some context, in that one can tell that the results were found because “SAP” was found in the books' titles, and not because SAP is the publisher, or author. “SAP” may also be highlighted in the results, providing context.

A block diagram of a computer system that executes programming for performing the above functions is shown in FIG. 5. In one embodiment, multiple such computer systems are utilized in a distributed network to implement multiple components in a transaction based environment. An object oriented architecture may be used to implement such functions and communicate between the multiple systems and components. One example computing device in the form of a computer 510, may include a processing unit 502, memory 504, removable storage 512, and non-removable storage 514. Memory 504 may include volatile memory 506 and non-volatile memory 508. Computer 510 may include—or have access to a computing environment that includes—a variety of computer-readable media, such as volatile memory 506 and non-volatile memory 508, removable storage 512 and non-removable storage 514. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 510 may include or have access to a computing environment that includes input 516, output 518, and a communication connection 520. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 502 of the computer 510. A hard drive, CD-ROM, and RAM are some examples of articles including a computer-readable medium. The term “computer readable medium” is also used to represent carrier waves on which the software is transmitted. For example, a computer program 525 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer 510 to provide generic access controls in a COM based computer network system having multiple users and servers.

The Abstract is provided to comply with 37 C.F.R. § 1.72(b) to allow the reader to quickly ascertain the nature and gist of the technical disclosure. The Abstract is submitted with the understanding that it will not be used to interpret or limit the scope or meaning of the claims.

1. A method comprising:
receiving a search string to be applied to structured data;
obtaining a concatenated version of the structured data;
applying the search string to the concatenated version to obtain search results; and
generating a list of results with context information and information from different portions of the structured data.

2. The method of claim 1 wherein the structured data comprises records, wherein each record has multiple fields forming columns.

3. The method of claim 2 wherein selected multiple fields are concatenated to form the concatenated version of the structured data.

4. The method of claim 2 wherein the results comprise records.

5. The method of claim 4 wherein the different portions of the structured data comprise information from different fields of each record.

6. The method of claim 5 wherein the columns of fields have associated descriptions.

7. The method of claim 6 wherein the context information comprises associated descriptions of a field column.

8. The method of claim 1 wherein the database comprises a catalog of items.

9. The method of claim 8 wherein the items comprise goods, materials and services.

10. The method of claim 1 wherein the list of results comprises images.

11. The method of claim 1 wherein the list of results comprises different portions of the structured data that matched the search string.

12. A computer readable medium having instructions for causing a computer to perform a method comprising:
receiving a search string to be applied to structured data;
obtaining a concatenated version of the structured data;
applying the search string to the concatenated version to obtain search results; and
generating a list of results with context information and information from different portions of the structured data.

13. The method of claim 12 wherein the structured data comprises records, wherein each record has multiple fields forming columns, and further wherein the list of results comprises an associated description of a field column.

14. The method of claim 12 wherein the list of results comprises images.

15. The method of claim 12 wherein the list of results comprises different portions of the structured data that matched the search string.

17. A system comprising:
a module that receives a search string to be applied to structured data;
a module that obtains a concatenated version of the structured data;
a module that applies the search string to the concatenated version to obtain search results;
a module that generates a list of results with context information and information from different portions of the structured data.

18. The system of claim 17 wherein the structured data comprises records, wherein each record has multiple fields forming columns, and further wherein the list of results comprises an associated description of a field column.

19. The system of claim 17 wherein the list of results comprises images.

20. The system of claim 17 wherein the list of results comprises different portions of the structured data that matched the search string.
